(19) United States
(12) Patent Application Publication
(10) Pub. No.: US 2013/0031085 A1
(43) Pub. Date: Jan. 31, 2013

(54) DOCBASE MANAGEMENT SYSTEM AND IMPLENTING METHOD THEREOF

(71) Applicants: Donglin Wang, Beijing (CN); Xu Gao, Beijing (CN)

(72) Inventors: Donglin Wang, Beijing (CN); Xu Gao, Beijing (CN)

(73) Assignee: SURSEN CORP., Beijing (CN)

(21) Appl. No.: 13/645,382

(22) Filed: Oct. 4, 2012

Related U.S. Application Data
(63) Continuation-in-part of application No. 12/391,495, filed on Feb. 24, 2009, now Pat. No. 8,312,008.
Application No. 12/391,495 is a continuation of application No. PCT/CN2007/070476, filed on Aug. 14, 2007.
Application No. PCT/CN2007/070476 is a continuation-in-part of application No. 12/133,280, filed on Jun. 4, 2008.
Application No. 12/133,280 is a continuation-in-part of application No. PCT/CN2006/003296, filed on Dec. 5, 2006.

(30) Foreign Application Priority Data
Dec. 5, 2005 (CN) 200510126683.6
Dec. 9, 2005 (CN) 200510131073.5
Aug. 25, 2006 (CN) 200610126538.2

(51) Int. Cl. G06F 17/30

(52) U.S. Cl. 707/718; 707/E17.008; 707/E17.017

(57) ABSTRACT

The present invention discloses a docbase management system, including a first module, adapted to parse a received invocation from an application and generate an execution plan which comprises operations on physical storage; a second module, adapted to execute the execution plan to schedule a third module to execute the operations on physical storage in the execution plan; and the third module, adapted to execute the operations on physical storage in the execution plan under the scheduling of the second module. Since the implementation of the docbase management system is divided into hierarchies, and the hierarchies are independent of each other, the docbase management system is well extendable, scalable and maintainable.

### CROSS-REFERENCE TO RELATED APPLICATION

The application is a continuation in part of U.S. patent application Ser. No. 12/391,495, filed Feb. 24, 2009, which claims priority of PCT/CN20070070476 (filed on Aug. 14, 2007), which claims priority of Chinese patent application 200610126538.2(filed on Aug. 25, 2006), and the application is also a continuation in part of U.S. patent application Ser. No. 12/133,280 (filed on Jun. 4, 2008), which is a continuation-in-part of International Application No. PCT/CN2006/003296 (filed on Dec. 5, 2006), which claims priority to Chinese Application No. 200510126683.6 (filed Dec. 5, 2005), and 200510131073.5 (filed on Dec. 9, 2005), the contents of which are incorporated herein by reference.

### FIELD OF THE INVENTION

The present invention relates to electronic document processing technologies and particularly to a docbase management system and an implementing method thereof.

### BACKGROUND OF THE INVENTION

A docbase management system provides the functions of organizing, managing, securing, displaying and storing massive documents. A prior application with the application number of CN200510131.072.0, filed by the same Applicant of the present application, provides a document processing system which includes a docbase management system, a storage device and an application, wherein data of the docbase management system are saved in the storage device and the docbase management system is connected with the application via a standard invocation interface. The operations to be performed on a document by the application include operations on a predefined universal document model. The application issues instructions to the docbase management system via the standard invocation interface, the process of which also may be called as invocation from the application, the docbase management system performs corresponding operations on data of the docbase in the storage device according to the received instructions.

Since the docbase management system involves a great amount of logic concepts and operations and supports many functions, it is very difficult to create a well extendable, scalable and maintainable docbase management system. The problem can only be approached in a perspective of the system architecture; otherwise the docbase management system cannot be satisfactorily extendable, scalable and maintainable.

### BRIEF DESCRIPTION OF THE DRAWINGS

FIG. 1 is a schematic illustrating hierarchical structure of the docbase management system in accordance with the present invention.

FIG. 2 is a schematic illustrating the docbase management system in accordance with the present invention.

FIG. 3 is a flow chart of the method for implementing the docbase management system in accordance with the present invention.

### DETAILED DESCRIPTION OF THE INVENTION

This invention is hereinafter further described in detail with reference to the accompanying drawings as well as four embodiments so as to make the objective, technical scheme and merits thereof more apparent.

The system for processing the document may comprise an application and a platform software (such as docbase management system). The application performs an operation on abstract unstructured information by issuing one or more instructions to the platform software. The platform software receives the instructions, maps the operation on abstract unstructured information to the operation on storage data corresponding to the abstract unstructured information, and performs the operation on the storage data. It is noted that the abstract unstructured information are independent of the way in which the storage data are stored.

An embodiment of the present invention also provides a machine readable medium having instructions stored thereon that when executed cause a system to: perform an operation on abstract unstructured information by issuing instruction(s) to a platform software, wherein said abstract unstructured information are independent of the way in which the corresponding storage data are stored.

An embodiment of the present invention also provides a machine readable medium having instructions stored thereon that when executed cause a system to: receive an instruction from an application which performs an operation on abstract unstructured information by issuing the instruction(s); perform the operation on storage data corresponded to the abstract unstructured information according to the said instruction; wherein said abstract unstructured information are independent of a way in which said storage data are stored.

An embodiment of the present invention also provides a computer-implemented system, comprising: means for performing an operation on abstract unstructured information by issuing instruction(s); means for receiving the said instruction and performing the operation on storage data corresponded to the abstract unstructured information according to the said instruction; wherein said abstract unstructured information are independent of a way in which said storage data are stored.

An embodiment of the present invention also provides a method for processing document data, comprising: a first application creating first abstract unstructured information by issuing first instruction(s) to a platform software; the said platform software receiving the said first instruction(s) and creating storage data corresponding to the said first abstract unstructured information; a second application issuing second instruction(s) indicating opening the said storage data to the said platform software; the said platform software opening and parsing the said storage data according to the second instruction(s), returning second abstract unstructured information corresponded to the said storage data to the second application; wherein said abstract unstructured information are independent of a way in which said storage data are stored.

An embodiment of the present invention also provides a method of processing document data, comprising: a first platform software parsing first storage data in first data format, generating first abstract unstructured information; the said application retrieving information from first abstract unstructured information by issuing first instructions, creating second abstract unstructured information which resembles with the first abstract unstructured information by issuing second instruction(s) to a second platform software; the second platform creating second storage data in second data format corresponded to the second abstract unstructured information; wherein said abstract unstructured information are independent of a way in which said storage data are stored.

Within the present invention, storage data refer to various kinds of information maintained or stored on a storage device (e.g., a non-volatile persistent memory such as a hard disk drive, or a volatile memory) for long-term usage and such data can be processed by a computing device. The storage data may include complete or integrated information such as an office document, an image, or an audio/video program, etc. The storage data are typically contained in one disk file, but such data may also be contained in multiple (related) files or in multiple fields of a database, or an area of an independent disk partition that is managed directly by the platform software instead of the file system of the OS. Alternatively, storage data may also be distributed to different devices at different places. Consequently, formats of the storage data may include various ways in which the information can be stored as physical data as described above, not just formats of the one or more disk files.

Storage data of a document can be referred to as document data and it may also contain other information such as security control information or editing information in addition to the information of visual appearance of the document. A document file is the document data stored as a disk file.

Here, the word “document” refers to information that can be printed on paper (e.g., static two-dimension information). It may also refer to any information that can be presented, including multi-dimension information or stream information such as audio and video.

In some embodiments, an application performs an operation on an (abstract) document, and it needs not to consider the way in which the data of the document are stored. A platform software (such as a docbase management system) maintains the corresponding relationship between the abstract document and the storage data (such as a document file with specific format), e.g., the platform software maps an operation performed by the application on the abstract document to an operation actually on the storage data, performs the operation on the storage data, and returns the result of such operation back to the application when the return of the result is requested.

In some embodiments, the abstract document can be extracted from the storage data, and different storage data may correspond to the same abstract document. For example, when the abstract document is extracted from visual appearance (also called layout) of the document, different storage data having the same visual appearance, no matter the ways in which they are stored, may correspond to the same abstract document. For another example, when a Word file is converted to a PDF file that has same visual appearance, the Word file and the PDF file are different storage data but they correspond to the same abstract document. Even when the same document is stored in different versions of Word formats, these versions of Word files are different storage data but they correspond to the same abstract document.

In some embodiments, in order to record the visual appearance properly, it would be better to record position information of visual contents, such as text, image and graphic, together with resources referenced, such as linked pictures and nonstandard fonts, to ensure fixed position of the visual contents and to guarantee that the visual contents is always available. A layout-based document meets the above requirements and is often used as storage data of the platform software.

The storage data created by platform software is called universal data since it is accessible by standard instructions and can be used by other applications that conform to the interface standard. Besides universal data, an application is also able to define its own unique data format such as office document format. After opening and parsing a document with its own format, the application may request creating a corresponding abstract document by issuing one or more standard instructions, and the platform software creates the corresponding storage data according to the instructions. Although the format of the newly created storage data may be different from the original data, the newly created storage data, the universal data, corresponds to the same abstract document with the original data, e.g., it resembles the visual appearance of the original data Consequently, as long as any document data (regardless of its format) corresponds to an abstract document, and the platform software is able to create a storage data corresponding to the abstract document, any document data can be converted to an universal data that corresponds to same abstract document and is suitable to be used by other applications, thus achieving document interoperability between different applications conforms to the same interface standard.

For a non-limiting example, an interoperability process involving two applications and one platform software is described below. The first application creates first abstract document by issuing a first set of instructions to the platform software, and the platform software receives the first set of instructions from the first application and creates a storage data corresponding to the first abstract document. The second application issues a second set of instructions to the platform software to open the created storage data, and the platform software opens and parses the storage data according to the second set of instructions, generating second abstract document corresponding to the said storage data. Here, the second abstract document is identical to or closely resembles the first abstract document and the first and second sets of instructions conform to the same interface standard, making it possible for the second application to open the document created by first application.

For another non-limiting example, another interoperability process involving one application and two platform software is described below. The first platform software parses first storage data in first data format, generates a first abstract document corresponding to the storage data. The application retrieves all information from the first abstract document by issuing a first set of instructions to the first platform software. The application creates a second abstract document which is identical to or closely resembles the first abstract document by issuing a second set of instructions to the second platform software. The second platform creates second storage data in second data format according the second set of instructions. Here, the first and second sets of instructions conform to the same interface standard, enabling the application to convert data between different formats and retain the abstract feature unchanged. The interoperability process involving multiple applications and multiple platform software can be deduced from the two examples above.

Due to limiting factors such as document formats and functions of relative software, the storage data may not be mapped to the abstract document with 100% accuracy and there may be some deviations. For a non-limiting example, such deviations may exist regardless of the precision floating point numbers or integers used to store coordinates of the visual contents. In addition, there may be deviations between the displaying/printing color and the predefined color if the software used for displaying/printing lacks necessary color management functions. If these deviations are not significant (for non-limiting examples, a character's position deviated 0.01 mm from where it should be, or an image with lossy compression by JPEG), these deviations can be ignored by users. The degree of deviation accepted by the users is related to practical requirements and other factors, for example, a professional an designer would be stricter with the color deviation than most people. Therefore, the abstract document may not be absolutely consistent with the corresponding storage data and displaying/printing results of different storage data corresponding to the same abstracted visual appearance may not be absolutely same with each other. Even if same applications are used to deal with the same storage data, the presentations may not be absolutely the same. For example, the displaying results under different screen resolutions may be slightly different. In the present invention, “similar” or “consistent with” or “closely resemble” is used to indicate that the deviation is acceptable, (e.g., identical beyond a predefined threshold or different within a predefined threshold). Therefore, storage data may correspond to, or be consistent with, a plurality of similar abstract documents.

The corresponding relationship between the abstract document and the storage data can be established by the platform software in many different ways. For example, the corresponding relationship can be established when opening a document file, the platform software parses the storage data in the document file and forms an abstract document to be operated by the application. Alternatively, the corresponding relationship can be established when platform software receives an instruction indicating creating an abstract document from an application, the platform software creates the corresponding storage data. In some embodiments, the application is aware of the storage data corresponding to the abstract document being processed (e.g., the application may inform the platform software where the storage data are, or the application may read the storage data into memory and submit the memory data block to the platform software). In some other embodiments, the application may “ignore” the storage data corresponding to the operated abstract document. For a non-limiting example, the application may require the platform software to search on Internet under certain condition and open the first searched documents.

Generally speaking, the abstract document itself is not stored on any storage device. Information used for recording and describing the abstract document can be included in the corresponding storage data or the instruction(s), but not the abstract document itself. Consequently, the abstract document can be called alternatively as a virtual document.

In some embodiments, the abstract document may have a structure described by a document model, such as a universal document model described hereinafter. Here, the statement “document data conform to the universal document model” means that the abstract document extracted from the document data conforms to the universal document model. Since the universal document model is extracted based on features of paper, any document which can be printed on a paper conforms to the document model, making such document model “universal”.

In some embodiments, other information such as security control, document organization (such as the information about which docset a document belongs to), invisible information like metadata, interactive information like navigation and thread, can also be extracted from the document data in addition to visual appearance of the document. Even multi-dimension information or stream information such as audio and video can be extracted. All those extracted information can be referred to jointly as abstract information. Since there is no persistent storage for the abstract information, the abstract information also can be referred to as virtual information. Although most of embodiments of the present invention are based on the visual appearance of the document, the method described above can also be adapted to other abstract information, such as security control, document organization, multi-dimension or stream information.

There are various ways to issue the instruction used for operating on the abstract information, such as issuing a command string or invoking a function. An operation on the abstract information can be denoted by instructions in different forms. The reason why invoking a function is regarded as issuing the instruction is that addresses of difference functions can be regarded as different instructions respectively, and parameter(s) of the function can be regarded as parameter(s) of the instruction. When the instruction is described under “an operation action+an object to be operated” standard, the object in the instruction may either be the same or different from an object of the universal document model. For example, when setting the position of a text object of a document, the object in the instruction may be the text object, which is the same as the object of the universal document model, or it may be a position object of the text which is different with the object of the universal document model. In actual practice, it will be convenient to unify the objects of the instructions and the objects of universal document model.

The method described above is advantageous for document processing as it separates the application from the platform software. In practice, the abstract information and the storage data may not be distinguished strictly, and the application may even operate on the document data directly by issuing instruction to the platform software. Under such a scenario, the instruction should be independent of formats of the document data in order to maintain universality. More specifically, the instruction may conform to an interface standard independent of the formats of the document data, and the instruction may be sent through an interface layer which conforms to the interface standard. However, the interface layer may not be an independent layer and may comprise an upper interface unit and a lower interface unit, where the upper interface unit is a part of application and the lower interface unit is a part of platform software.

The universal document model can be defined with reference to the features of paper since paper has been the standard means of recording document information, and the functions of paper are sufficient to satisfy the practical needs in work and living.

If a page in a document is regarded as a piece of paper, all information put down on the paper should be recorded. There is a demand for the universal document model, which is able to describe all visible contents on the page. The page description language (e.g., PostScript) in the prior art is used for describing all information to be printed on the paper and will not be explained herein. However, the visible contents on the page can always be categorized into three classes: texts, graphics and images.

When the document uses a specific typeface or character, the corresponding font is embedded into the document to guarantee identical output on the screens/printers of different computers. The font resources are shared to improve storage efficiency, i.e., only one font needs to be embedded when the same character is used for different places. An image sometimes may be used in different places, e.g., the image may be used as the background images of all pages or as a frequently appearing company logo and it will be better to share the image, too.

Obviously, as a more advanced information process tool, the universal document model not only imitates paper, but also develops some enhanced digital features, such as metadata, navigation, a thread, and a thumbnail image, which also can be called minipage, etc. Metadata includes data used for describing data, e.g., the metadata of a book includes in information about the author, publishing house, publishing date and ISBN. Metadata is a common term in the industry and will not be explained further herein. Navigation, also a common term in the industry, includes information similar to the table of contents of a book. The thread information describes the location of a passage and the order of reading, so that when a reader finishes a screen, the reader can learn what information, should be displayed on the next screen. The thread also enables automatic column shift and automatic page shift without the reader manually appointing a position by the reader. The thumbnail image includes miniatures of all pages. The miniatures are generated in advance so that the reader may choose a page to read by checking the miniatures.

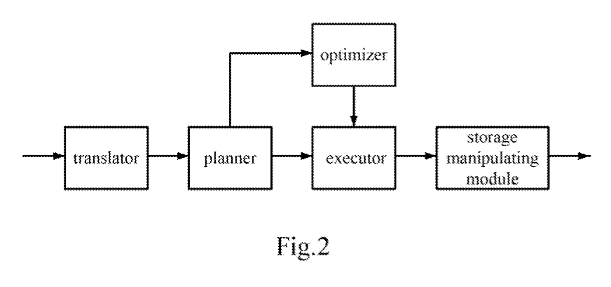

FIG. 2 shows a universal document model in a preferred embodiment of the present invention. As shown in FIG. 2, the universal document model includes multiple hierarchies including a document warehouse, docbase, docset, document, page, layer, object stream which also can be called object group, and layout object.

The document warehouse consists of one or multiple docbases. The relation among docbases is not as strictly regulated as the relation among hierarchies within a docbase. Docbases can be combined and separated simply without modifying the data of the docbases, and usually no unified index is set up for the docbases (especially a fulltext index), so most search operations on the document warehouse traverse the indexes of all the docbases without an available unified index. Every docbase consists of one or multiple docsets and every docset consists of one or multiple documents and possibly a random number of sub docsets. A document includes a normal document file (e.g., a .doc document) in the prior art. The universal document model may define that a document may belong to one docset only or belong to multiple docsets. A docbase is not a simple combination of multiple documents but a tight organization of the documents, which can create the great convenience after unified search indexes are established for the document contents.

Every document consists of one or multiple pages in an order (e.g., from the front to the back), and the size of the pages may be different. Rather than in a rectangular shape, a page may be in a random shape expressed by one or multiple closed curves.

Further, a page consists of one or multiple layers in an order (e.g., from the top to the bottom), and one layer is overlaid with another layer like one piece of glass over another piece of glass. A layer consists of a random number of layout objects and object streams. The layout objects include statuses (typeface, character size, color, ROP, etc.), texts (including symbols), graphics (line, curve, closed area filled with specified color, gradient color, etc.), images (TIF, JPEG, BMP, JBIG, etc.), semantic information (title start, title end, new line, etc.), source file, script, plug-in, embedded object, bookmark, hyperlink, streaming media, binary data stream, etc. One or multiple layout objects can form an object stream, and an object stream can include a random number of sub-object streams.

The docbase, docset, document, page, and layer may further include metadata (e.g., name, time of latest modification, etc., the type of the metadata can be set according to practical needs) and/or history. The document may further include navigation information, thread information and thumbnail image. And the thumbnail image also may be placed in the page or the layer. The docbase, docset, document, page, layer, and object stream may also include digital signatures. The semantic information had better follow layout information to avoid data redundancy and to facilitate the establishment of the relation between the semantic information and the layout. The docbase and document may include shared resources such as a font and an image.

Further the universal document model may define one or multiple roles and grant certain privileges to the roles. The privileges are granted based on docbase, docset, document, page, layer, object stream and metadata etc. Regard docbase, docset, document, page, layer, object stream or metadata as a unit for granting privileges to a role, and the privileges define whether the role is authorized to read, write, copy or print the unit for granting.

The universal document model goes beyond the conventional one document for one file. A docbase includes multiple docsets, and a docset includes multiple documents. Fine-grained access and security control is applied to document contents in the docbase so that even a single text or rectangle can be accessed separately in the docbase while the prior document management system is limited to access as far as a file name, i.e., the prior document management system can not access to contexts of a file separately.

In embodiments of the present invention, the implementation of the docbase management system is divided into multiple hierarchies and standards for interfaces between hierarchies are defined.

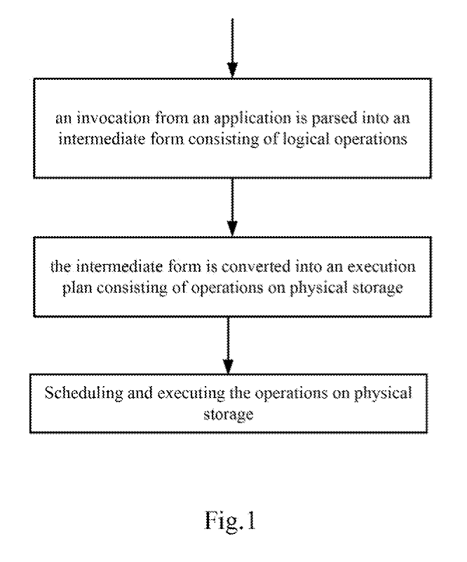

FIG. 1 is a schematic illustrating hierarchical structure of the docbase management system in accordance with the present invention. As shown in FIG. 1, in the present invention, the implementation of the docbase management system is divided into multiple hierarchies, which specifically includes: parsing an invocation from an application to build an intermediate form which comprises logical operations, converting the intermediate form which comprises logical operations into an execution plan which comprises operations on physical storage, and executing the execution plan.

In this way, as long as outputs of the hierarchies conform to the corresponding interface standards, the hierarchies may be implemented in different ways, and the docbase management system can be well extendable, scalable and maintainable.

FIG. 2 shows a docbase management system in accordance with the present invention. As shown in FIG. 2, the docbase management system includes a parser, a planner, an executor and a storage manipulating module.

The parser is adapted to parse a received invocation from an application to build an intermediate form consisting of objects and/or operations of a universal document model.

The planner is adapted to convert the intermediate form parsed by the parser into an execution plan consisting of operations on physical storage.

The logical operations which constitute the intermediate form are high level concept. A logical operation may be mapped to one single physical operation or a sequence of physical operations, and there are maybe more than one mapping possibilities. Therefore an intermediate form may be converted into one of plurality of execution plans. So each time the planner is invoked, it may generate different execution plans based on the same intermediate form, however, those different execution plans are equivalent to one another.

The executor is adapted to execute the execution plan converted by the planner to schedule the storage manipulating module to execute the operations on physical storage in the execution plan.

The storage manipulating module is adapted to execute the operations on physical storage in the execution plan under the scheduling of the executor.

The above is a specific structure of the docbase management system. As long as outputs of the hierarchies conform to the corresponding interface standards, the hierarchies may be implemented in different ways, and the docbase management system can be well extendable, scalable and maintainable.

The modules in the above docbase management system will be described in detail as follows.

Specifically speaking, the intermediate form outputted by the parser conforms to interface standard. Specifically, the intermediate form may include a syntax tree or a Document Object Model (DOM) tree. The invocation from the application to the docbase management system via a standard interface is processed by the parser first. The standard interface may be an Unstructured Operation Markup Language (UOML) interface using an Extensible Markup Language (XML), as explained in the prior application of the docbase management system, or may be in form of command strings, or may be in other forms, all of which should conform to the universal document model explained in the prior application of the docbase management system.

The invocation from the application is parsed by the parser based on lexis and syntax and converted into the intermediate form which consists of objects and/or operations of the universal document model and conforms to the interface standard.

In practical application, when the standard interface uses XML, the parser in the docbase management system may be an XML parser which is adapted to parse the invocation from the application and generate a DOM tree. When the standard interface is in form of command strings which usually conform to a Look Ahead Left to Right Parsing (LALR [1]) grammar, if the grammar definition is given, the parser in the docbase management system may be a lexical and syntax parser created by a Lexical complier (Lex) and a Yet Another Compiler Compiler (YACC). The Lex is a tool used for generating a scanner, i.e. a tool for generating a syntax analyzer. The YACC is an automatic tool used for generating a LALR(1) analyzer and the first version of YACC was published in early 1970s by Bell Laboratory (author of which is S. C. Johnson). The two tools are widely employed in platforms such as UNIX and DOS. The XML parsing and the Lex and YACC parsing processes are a part of the prior art.

The parsing of a standard interlace invocation in XML is explained as follows.

<call>

<stringVal val=“AppendLine” name=“MethodName”/>
<stringVal val=“0xabcd1234” name=“PathObj”/>
<compoundVal name=“LineObj”>

<line>

<start xCod=“1000.23” yCod=“2193.324”/>
<end xCod=“3233.234” yCod=“2342.234”/>

</line>

</compoundVal>

</call>

The above codes indicate a standard interface invocation in XML. The interface method is named Appendline and the task of the method is to append a line to a path object whose handle is 0xabcd1234, the coordinates of the two ends of the line are (1000.23, 2193.324) and (3233.234. 2342.234) respectively.

The parser parses the standard inter-ace invocation in XML and the result of the parsing is a DOM tree, which includes a root element named “call”, and three sub elements two named “string Val” and one named “compoundVal”.

The structure of the DOM tree is illustrated as follows:

call

stringVal
stringVal
compoundVal

A standard interface invocation in a customized language which conforms to LALR(1) grammar is as follows:

call with name=AppendLine, params=(PathObj= “0xabcd1234”,

LineObj=(StartPt=(1000.23, 2193.324), EndPt=(3233.234, 2342.234)));

The parser parses the customized invocation from the application by using a corresponding lexical and syntax parser and then generates a syntax tree. The lexical and syntax parser can be created by invoking Lex and YACC in advance to process lexis and syntax defined by the customized language of Lex and YACC respectively. The syntax tree can be expressed with C structure:

struct SyntaxTree
{

struct Node * pRoot ;

} ;
struct Node
{
struct Node *pLeft;
struct Node *pRight;
......
}

The tree structure is similar to the structure of the preceding DOM tree.

The following example illustrates the conversion from logical operations to physical operations by the planner when the intermediate form includes a syntax tree.

All logical operations L_OP in the syntax tree are enumerated; herein the logical operations also may be sequences of logical operations. Firstly, a physical operation set (P_OP₁, P_OP₂, . . . , P_OPₘ) which corresponds to L_OP is obtained: herein the physical operation P_OPⱼ also may be a sequence of physical operations. And then, a physical operation P_OPᵢ is chosen for the L_OP. Finally, the preceding steps to choose a physical operation for every logical operation are repeated until all the logical operations in the syntax tree are replaced with corresponding physical operations and an execution plan is thus generated.

The conversion of the DOM tree or other kinds of intermediate forms is similar to the conversion process described above.

The intermediate form that includes the DOM tree described above is converted by the planner into an execution plan as follows:

AppendLine

PathObj
CreateLine

StartPt
EndPt

The root node AppendLine of the execution plan is an operation, the first sub node PathObj is the handle of object Path, the second sub node CreateLine is also an operation used for creating a line object, and the two sub nodes of CreateLine respectively indicate the starting point and the ending points of the line to be created.

The result of the operation CreateLine includes a line object, and the operation Appendline will add the line object to the object Pats.

For the executor in the docbase management system shown in FIG. 2, because an execution plan usually includes a tree which comprises operations on physical storage, so the executor executes the whole execution plan by performing recursion from the root node of the tree corresponding to the execution plan to the leaf nodes of the tree, and scheduling the storage manipulating module to execute the actual operations from the leaf nodes of the tree to the root node.

The following execution plan is an example to illustrate the operation of the executor:

OP1

Para1
Para2
OP2

Para3
Para4
OP3

Para5
Para6

OP1, OP2 and OP3 are three operations and Para1 to Para6 are six parameters of the operations respectively. The executor executes the execution plan according to the following order:

executing OP3 (Para5, Para6), and getting the result res3;

executing OP2 (Para3, Para4, res3), and getting the result res2:

executing OP3 (Para1, Para2, res2), and getting the result res1.

The storage manipulating module in the docbase management system shown in FIG. 2 may be built on varieties of physical or virtual physical storage layers and be restrained by different performances and scales accordingly.

In the practical application, an interface provided by the physical storage layer, i.e., an interface between the storage manipulating module and the physical storage layer, may affect that what kinds of physical operations can be put in the execution plan, so the execution plan generated by the planner also needs to depend on the preset interface. For example, when the physical storage layer provides only the read/write functions of binary streams, the physical operations in the execution plan possibly include only two physical operations: read and write. If the physical storage layer provides more functions, such as create a docbase, create a document set, etc., the execution plan may include more physical operations. The basic objects that the physical storage layer needs to provide include a docbase, document set, document, etc., and the physical storage layer also needs to provide functions of allocating, recycling and reading/writing physical storage.

When media such as a logical disk partition, physical disk, virtual storage and memory is adopted, the ways for implementing the storage manipulating modules in those different types of media are similar. The storage manipulating module may be built based on: a file system provided by the operating system, or a logical disk partition provided by the operating system, or an interface provided by the operating system for accessing the physical disk, or an interface directly accessing the physical disk bypassing the operating system, or an interface provided by the operating system for accessing the virtual memory or physical memory, or an interface directly accessing the physical memory bypassing the operating system, or the virtual storage device. The objects on the physical storage layer, such as docbase, document set and document, can be built accordingly.

The virtual storage may include remote storage, i.e., a physical storage in another computer device accessible through a system such as Network File System (NFS) or Distributive File System (DFS). The virtual storage may also include network storage, i.e., a storage provided by a network, such as the storage in a Storage Area Network (SAN), GRID, Peer-to-Peer (P2P) network, etc.

For example, in a file system, the storage manipulating module performs the following operations:

setting a directory as a docbase;

creating one or multiple document set directories under the docbase directory;

creating one or multiple files as the documents under a document set directory;

creating a page, layer, page content, etc., in a document.

The directory may finally have a structure shown as follows, wherein the documents are shown as the files under the doclist directory:

/......

docbase/

doclist/
doclist/
......

The above is the detailed description of implementation of the modules in the docbase management system in accordance with the present invention. From the above description, it can be seen that interfaces between different modules confirm to a universal interface standard. As long as the inputs and outputs are in compliance with the universal interface standard, the modules may be implemented in different ways so as to make the whole docbase management system well extendable, scalable and maintainable.

An intermediate form may be converted into different execution plans by the planner in the docbase management system. The execution plans are equivalent to one another, however, the time and space needed for executing the execution plans usually differ greatly. Therefore, whether the execution plan chosen from an execution plan set is preferable will greatly influence the performance of the docbase management system.

So, in an embodiment of the present invention, the docbase management system shown in FIG. 2 may further include an optimizer, which is adapted to select a preferable execution plan from the execution plan set corresponding to the intermediate form according to a preset judgment criterion.

Specifically, after the planner generates a number of execution plans, for example, the planner may generate a number of execution plans at random, the optimizer selects the optimum execution plan from the generated execution plan set according to the judgment criterion. It should be pointed out that the “optimum” execution plan is selected based on the judgment criterion or practical requirements. For example, an optimum execution selected to meet the judgment criterion which require shortest execution time may need large execution space, therefore the execution plan will not be the “optimum” when the judgment criterion require smallest execution space. The judgment criterion may be based on experience rules or the cost of the execution plan, i.e., the time or space cost of the execution plan or the combination of the time cost and the space cost of the execution plan.

In the practical application, the optimizer may be implemented in many ways and the following is examples.

The optimizer in the docbase management system shown in FIG. 2 may select the optimum execution plan according to priorities of the experience rules. Provided the judgment criterion of the optimizer includes L experience rules, namely R₁, R₂, . . . , R_{L}, and without loss of generality; the priorities of the experience rules follow the inequality R₁>R₂> . . . >R_{L}, the optimizer will work as follows.

Step a1: An execution plan set is initiated with all generated execution plans, and Rᵢ is set as the judgment criterion to be applied currently, wherein i=1 in the initial status.

Step a2: whether the execution plans in the execution plan set meet the judgment criterion Rᵢ is determined in turn. If an execution plan does not meet the judgment criterion Rᵢ, the execution, plan is marked and deleted from the execution plan set.

Step a3: if the execution plan set becomes empty, the execution plans marked in Step a2 are put into the execution plan set and whether i equals to L is determined, if i equals to L, an execution plan is selected from the execution plan set at random as the optimum execution plan based on priorities of the experience rules; otherwise 1 is added to i and Step a2 is repeated.

The optimizer in the docbase management system shown in FIG. 2 also may select the optimum execution plan according to weights of the experience rules. Provided the judgment criterion of the optimizer includes L experience rules, namely R₁, R₂, . . . , R_{L}, without loss of generality, the weight of the rule Rᵢ is identified as PRᵢ, and every execution plan has a weight, the optimizer will work as follows.

Step b1: the initial weights of all the execution plans are set to 0.

Step b2: whether the execution plans meet the judgment criterion Rᵢ (i=1, . . . , L) is determined in turn. If an execution plan meets the judgment criterion Rᵢ, PRᵢ is added to the weight of the execution plan.

Step b3: an execution plan with the largest weight is selected, as the optimum execution plan according to the weights of all the execution plans. When multiple execution plans have the same largest weight, any one of these execution plans may be selected as the optimum execution plan based on the weights of the experience rule.

Both the above two types of the optimizers select the optimum execution plan based on experience rules. In another embodiment of the present invention, the optimizer also may select the optimum execution plan based on the cost of the execution plan.

The cost of the execution plan includes time cost and space cost. The time cost includes the time spent on executing the whole execution plan, which mainly includes the disk I/O time. The space cost includes the maximum space that may possibly be occupied by a final result and intermediate results during the execution of the whole execution plan. The space cost is calculated based on the memory and disk space to be occupied.

If the optimum execution plan is selected based on the time cost of the execution plan, the optimizer divide an execution plan into basic operations, the time cost of each of the base operations is multiplied by the executing times of each of the base operations and the total time of the execution plan can be calculated by summing the multiplying results of the base operations. Usually the optimizer traverses the whole execution plan in recursion to learn how many times each of the basic operations will be carried out and then calculates the total time needed for the execution plan.

Unlike the calculation of time cost for the execution plan, the calculation of space cost usually refers the maximum space needed during the execution. The optimizer calculates from the bottom to the top in recursion, compares the space needed for current operation with current maximum space value, if the former one is larger, the optimizer replaces the current maximum space value with the space needed for the current operation. When the whole execution plan has been calculated, the maximum space needed for the execution plan, i.e., the space cost of the execution plan, is obtained.

In detail, the optimizer may select the optimum execution plan depending on the time costs of the execution plans. Provided an execution plan has a tree structure and the basic operations of the execution plan include (OP₁, OP₂, . . . , OPₙ), and the time cost function of the execution plan is indicated as TIME_CALC(NODE node), the calculation of TIME_CALC is show as follows.

c1: the initial execution time variable T is set to 0.

c2: T=T+ΣTIME_CALC(SUBᵢ) is calculated, wherein SUB₁, SUB₂, . . . , SUBₘ are the sub nodes of node and the dummy variable i ranges from 1 to m.

c3: the times of carrying out each basic operation concerning node is calculated, wherein C, indicates the times of carrying out OPᵢ and OTᵢ indicates the time needed for OPᵢ; and then T=T+ΣCᵢ*OTᵢ is calculated, wherein, the dummy variable i ranges from 1 to n.

c4: the value of T is returned as the result of TIME_CALC.

The optimizer also may select the optimum execution plan based the space costs of the execution plans. Provided an execution plan has a tree structure and the basic operations of the execution plan include (OP₁, OP₂, . . . , OPₙ), and the space cost function of the execution plan is indicated as SPAEC_CALC(NODE node), the calculation of SPACE_CALC is show as follows.

d1: the initial execution space variable S is set to 0.

d2: S=MAX(S, SPACE_CALC(SUBᵢ)) is executed, wherein SUB₁, SUB₂, . . . , SUBₘ are sub nodes of node and the dummy variable i ranges from 1 to m.

d3: the times of carrying out each basic operation concerning the node is calculated, wherein Cᵢ indicates the times of carrying out OPᵢ and OTᵢ indicates the space needed for OPᵢ; and then S=MAX(S, SUM(Cᵢ*OTᵢ)) is calculated, wherein, the dummy variable i ranges from 1 to n.

d4: the value of S is returned as the result of SPACE_CALC.

From the description above, it can be seen that the optimum execution plan is selected from the execution plans by the optimizer according to the judgment criterion, so the selected optimum execution plan usually requires lower time or space cost, therefore the performance of the whole docbase management system is improved.

In an embodiment of the present invention, the optimizer may select the optimum execution plan directly from the execution plans generated by the planner, as mentioned above. In addition, the optimizer also may optimize the execution plans generated by the planner by using an artificial intelligence algorithm, e.g., a genetic algorithm or an artificial neural network algorithm, and then select the optimum execution plan from the optimized execution plans.

The execution plans are optimized by associating the cost or other measurement parameters of the execution plans as a measurement function with a measurement in the intelligence algorithm, e.g., adaptability in the genetic algorithm or energy in a simulated annealing algorithm, and the space of the execution plans is searched by using those algorithms to get the partially optimized execution plans.

Several methods for optimizing the execution plans by the optimizer will be described as follows.

A method for optimizing the initial execution plans with the genetic algorithm is described as follows. For every initial execution plan, following steps are performed.

e1: an execution plan tree (a tree structure of the execution plan) is coded into strings to get a string set as the initial population for the genetic algorithm;

e2: the execution time or space is considered as a measurement function of adaptability, and the evolution of the initial population is started;

e3: once the number of offspring reaches a preset number, the evolution is stopped and then the final population is decoded into an execution plan (i.e., an optimized execution plan).

It should be pointed out that rather than the execution time or space, other measurement values, e.g., the times of acquiring the page bitmap of the document, also may be considered as the measurement function of adaptability.

A method for optimizing the initial execution plans with the simulated annealing algorithm is described as follows. For every initial execution plan in an execution plan set, following steps are performed.

f1: C is used to indicate the present execution plan and B is used to indicate the optimized execution plan. In the initial status, B is set as C;

f2: an initial temperature is set as T;

f3: an initial temperature decrease factor ALPHA is set as a value between 0 and 1;

f4: when T is greater than a preset halt temperature value FT, following operations are repeated in sequence;

f41: under the present temperature, when the number of times of carrying out the following operations is lower than a preset value COUNT, following operations are repeated in sequence;
f412: the present execution plan C is copied to a temporary execution plan W;
f413: W is adjusted finely at random, and during the adjusting process, it should be ensured that W is equivalent to C;
f414: the energy of C and W (i.e., the execution costs of C and W), namely Ec and Ew, are calculated respectively;
f415: if c>Ew, W is copied to C and B;
f416: if Ec<=Ew, following calculations are performed.
   the value of TEST is initialized as a random value between 0 and 1;
   DELTA=Ew−Ec is calculated;
   RESULT=EXP(−DELTA/T) is calculated;
   if RESULT is greater than TEST, is copied to C;
f42: the present temperature is lowered according to the equation T=T*ALPHA;
f5: the execution plan B is copied to C.

Besides the two algorithms described above, other algorithms such as an evolutionary algorithm, heuristic algorithm, branch and bound algorithm, hill climbing algorithm, artificial neural network algorithm or dynamic programming algorithm may also be adopted for optimizing the execution plans. The strategies used by other algorithms for optimizing the initial execution plans are similar to the two algorithms described above.

Through partially optimizing the initial execution plan, the cost of selected optimum execution plan is further lowered, and performance of the whole docbase management system is further improved.

It should be pointed out that any one or any combination of the parser, planner, optimizer, executor and the storage manipulating module in the present invention may be implemented as an independent module. For example, in the Windows system, the modules may be implemented as individual DLLs respectively or be combined into one DLL. In the Linux system, the modules may be implemented as individual .so files respectively or be combined into one .so file. In a Java environment, the modules may be implemented as individual .class files respectively or be combined into one .class file.

The modules may be developed with any of the languages including C, C++, Java, Python, Ruby, Perl, SmallTalk, Ada, Simula, Pascal, Haskell, etc.

In another embodiment, the optimizer in the docbase management system provided by the present invention is further adapted to optimize the selected preferable execution plan. At this time, the executor executes the optimized preferable execution plan to schedule the storage manipulating module to execute the operations on physical storage in the optimized preferable execution plan. The method of optimizing the preferable execution plan is similar with the process of optimizing the execution plans generated by the planner described above.

So, in an embodiment, the process for obtaining the execution plan executed by the executor may include:

the optimizer optimizes the execution plans and selects the preferable execution plan from the optimized execution plans, at the time, the executor executes the preferable execution plan; or,

the optimizer selects the preferable execution plan from the execution plans and then optimize the preferable execution plan, at the time, the executor executes the optimized preferable execution plan; or,

the optimizer optimizes the execution plans, selects the preferable execution plan from the optimized execution plans, and then optimize the selected preferable execution plan, at the time, the executor executes the optimized preferable execution plan. When the number of the execution plans generated by the planner is only one, the optimizer may directly optimize the only execution plan and the executer executes the optimized execution plan.

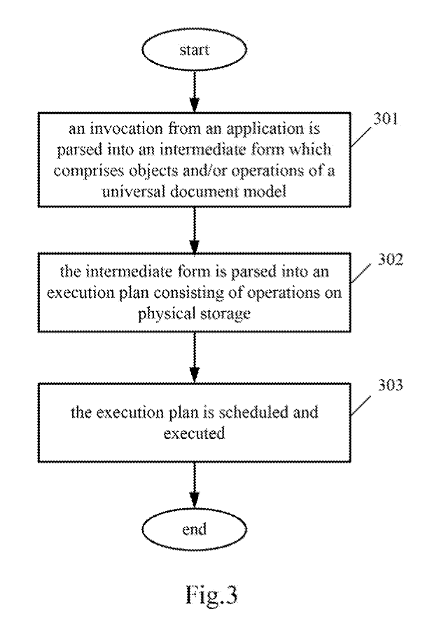

FIG. 3 is a flow chart of a method for implementing the docbase management system in accordance with the present invention. As shown in FIG. 3, the method for implementing the docbase management system includes following steps.

Step 301: an invocation from an application is parsed to build an intermediate form consisting of objects and/or operations of a universal document model.

The invocation from the application to the docbase management system via a standard interface may use the UOML described in a prior patent application document on the docbase management system, or may use command strings, whatever, the invocation from the application should confirm to the universal document model given in the prior patent application document on the docbase management system. The invocation from the application is parsed based on the lexis and the syntax and is converted into the intermediate form which comprises objects and/or operations of the universal document model and in compliance with a standard interface. When the standard interface uses XML, an XML parser may be adopted to generate a DOM tree. When the standard interface users command strings which usually follow LALR(1) grammar, as long as the definition of the grammar is given, the command strings can be parsed by a lexical and syntax parser created by Lex and YACC.

Step 302: the intermediate form is converted into an execution plan which comprises operations on physical storage.

The objects and/or operations of the universal document model which constitute the intermediate form are logical operations and the logical operations are high level concepts, therefore a logical operation may be mapped to one operation on physical storage or a sequence of operations on physical storage, one logical operation may be mapped to different operations or sequences. Therefore an intermediate form may be converted into execution plans. Different execution plans may be generated based on the same intermediate form.

Taking an intermediate form represented by the syntax tree as an example, the process of converting the intermediate form into an execution plan includes following steps.

Firstly, all logical operations L_OP in the syntax tree are enumerated. The logical operations also may be sequences of logical operations.

Then, a physical operation set (P_OP₁, P_OP₂, . . . , P_OPₘ) that corresponds to L_OP is obtained, in which the physical operation P_OPᵢ also may be a sequence of physical operations.

After that, a physical operation P_OPᵢ is chosen for the L_OP.

Finally, the preceding steps to choose a physical operation for every logical operation are repeated until all the logical operations in the syntax tree are replaced with corresponding physical operations and an execution plan is thus generated.

The conversion of the DOM tree or other kinds of intermediate forms is similar to the conversion process described above.

Step 303; the execution plan is scheduled and executed.

Recursion starts from the root node of the tree corresponding to the execution plan and goes from top to the bottom until leaf nodes of the tree are reached, and then the actual operations are performed from bottom to the top of the tree to complete the whole execution plan.

In the above method for implementing the docbase management system, when the interfaces between every two steps are in compliance with the standard interface standard, the steps are independent of each other. Therefore, the whole docbase management system is well extendable, scalable and maintainable.

In the above flow, if several execution plans are converted from the intermediate form in Step 302, Step 302 further includes the following steps.

Step 3021: the intermediate form which comprises objects and/or operations of the universal document model is converted into execution plans.

The objects and/or operations of the universal document model which constitute the intermediate form are logical operations, the logical operations are high level concepts, therefore a logical operation may be mapped to one physical operation or a sequence of physical operations, one logical operation may also be mapped to different physical operations or sequences. Therefore an intermediate form may be converted into execution plans. And the execution plans may be generated at random based the intermediate form which comprises the logical operation.

Step 3022: an optimum execution plan is selected from the execution plans according to a judgment criterion.

In the above Step 3022, the optimum execution plan is selected from a generated execution plan set according to the judgment criterion. It should be pointed out that the “optimum” execution plan is selected based on the judgment criterion or practical requirements. For example, an optimum execution selected to meet the judgment criterion which require shortest execution time may need large execution space, therefore the execution plan will not be the “optimum” when the judgment criterion require smallest execution space. The judgment criterion may be based on experience rules or the cost of the execution plan, i.e., the time or space cost of the execution plan or the combination of the time cost and the space cost of the execution plan.

Specifically, operations in Step 3022 may be implemented in many ways and the following is examples.

A method for selecting the optimum execution plan according to priorities of the experience rules is described as follows. Provided the judgment criterion includes L experience rules, namely R₁, R₂, . . . , R_{L}, and without loss of generality, the priorities of the experience rules follow the inequality R₁>R₂> . . . >R_{L}, the selection process is explained as follows.

b1. an execution plan set is initiated with all the generated execution plans and Rᵢ is set as the judgment criterion to be applied currently, wherein i=1 in the initial status.

b2. whether the execution plan in the execution plan set meet the judgment criterion Rᵢ is determined in turn. If an execution plan does not meet the judgment criterion Rᵢ, the execution plan is marked and deleted from the execution plan set.

b3. If the execution plan set becomes empty, the execution plans marked in Step b2 are put into the execution plan set and whether i equals to L is determined. If i equals to L, proceed to the next step; otherwise 1 is added to i and Step b2 is repeated.

An execution plan is selected from the execution plan set at random as the optimum execution plan.

A method for selecting the optimum execution plan according to weights of the experience rules is described as follows. Provided the judgment criterion includes L experience rules, namely R₁, R₂, . . . , R_{L}, and without loss of generality, the weight of the rule Rᵢ is identified as PRᵢ, the selection process is explained as follows.

The initial weights of all the execution plans are set to 0.

Whether the execution plans meet the judgment criterion Rᵢ (i=1 . . . , L) is determined in turn. If an execution plan meets the judgment criterion Rᵢ, PRᵢ is added to the weight of the execution plan.

An execution plan with the largest weight is selected as the optimum execution plan according to the weights of all the execution plans. When multiple execution plans have the same largest weight, any one of the execution plans may be selected as the optimum execution plan.

The above describes two examples of selecting the optimum execution plan according to experience rules, and the following will describe the process of selecting the optimum execution plan according to the cost of the execution plans.

The cost of the execution plan includes time cost and space cost. The time cost includes the time spent on executing the whole execution plan and the space cost includes the maximum space that may possibly be occupied by a final result and intermediate results during the execution of the whole execution plan. The disk I/O time involved in the execution makes up the main part of the time cost, so the calculation of the time cost mainly includes the calculation of the disk I/O time. The space cost is calculated based on the memory and disk space to be occupied.

The method for calculating the time cost and the space cost of the execution plans is given in the preceding description of the optimizer.

Through generating the execution plans and selecting the optimum execution plan described in the above steps, the cost of the optimum execution plan is relatively lower. Therefore, the performance of the docbase management system is improved.

In the method for implementing the docbase management system provided by an embodiment of the present invention, between Step 3021 and Step 3022, the method may further include the process of optimizing the execution plans. And after the optimizing process, partially optimized execution plans may be obtained.

So in Step 3022, the optimum execution plan may be selected from the optimized execution plans.

The execution plans are optimized by associating the cost or other measurement parameters of the execution plans as a measurement function with measurement in an intelligence algorithm, e.g., adaptability in the genetic algorithm or energy in the simulated annealing algorithm, and then the space of the execution plans is searched by using those algorithms to get the partial optimized execution, plans.

The algorithm used for optimizing the execution plans may include the genetic algorithm, the simulated annealing algorithm, etc., and the specific process is explained in the preceding description of the optimizer.

Besides the two algorithms described above, other algorithms such as an evolutionary algorithm, heuristic algorithm, branch and bound algorithm, hill climbing algorithm, artificial neural network algorithm or dynamic programming algorithm may also be adopted for optimizing the execution plans. The strategies used by other algorithms for optimizing the initial execution plans are similar to the two algorithms described above.

Through partially optimizing the initial execution plans, the cost of selecting optimum execution plan is further lowered, and performance of the whole docbase management system is further improved.

To sum up, in the docbase management system and the method for implementing the docbase management system provided by the present invention, the implementation of docbase management system is divided into a plurality of hierarchies and the hierarchies are independent of each other, which makes the docbase management system well extendable, scalable and maintainable. Also through the optimizer and the optimization algorithms provided by the present invention, the optimum execution plan is selected from execution plans so as to improve the execution performance and eventually improve the performance of the whole docbase management system. In addition, the initial execution plans generated by the planner is partially optimized, so that the cost of the selected optimum execution plan is further lowered and performance of the whole docbase management system is further improved.

The above technical scheme has provided a specific method for implementing the docbase management system. It can be seen from the above technical scheme that, in the present invention, the implementation of docbase management system is divided into a plurality of hierarchies. The hierarchies are independent of each other, which makes the docbase management system well extendable, scalable and maintainable. Also in the present invention, the preferable execution plan is selected from execution plans so as to improve the execution performance and eventually improve the performance of the whole docbase management system. In addition, the initial execution plans generated by the first module is partially optimized, so that the cost of the selected preferable execution plan is lowered and performance of the whole docbase management system is improved.

The foregoing is only preferred embodiments of the present invention. The protection scope of the present invention, however, is not limited to the above description. Any alteration or substitution that is within the technical scope disclosed by the present invention and can easily occur to those skilled in the art should be covered in the protection scope of the present invention. Hence the protection scope of the present invention should be determined by the statements in Claims.

1. A method for implementing a docbase management system, wherein visual appearance of a document is described by an abstract universal document model, the method comprising:
parsing an invocation from an application, the invocation indicating operations on the universal document model,
generating an execution plan which comprises operations on physical storage data; and
scheduling the operations in the execution plan and executing the operations in the execution plan on physical storage data.

2. The method according to claim 1, wherein, parsing an invocation from an application and generating an execution plan which comprises operations on physical storage data comprises:
parsing an invocation from an application to build an intermediate from which comprises objects and/or operations of the abstract universal document model;
converting the intermediate form into an execution plan which comprises operations on physical storage data.

3. The method according to claim 2, wherein converting the intermediate form into an execution plan comprises:
converting the intermediate form which comprises objects and/or operations of the abstract universal document model into execution plans; and
selecting a preferable execution plan from the execution plans according to a judgment criterion:
wherein scheduling the operations in the execution plan and executing the operations in the execution plan on physical storage data in one of the formats comprises:
scheduling the operations in the preferable execution plan and executing the operations in the preferable execution plan on physical storage data.

4. The method according to claim 3, wherein, the execution plans are generated at random.

5. The method according to claim 3, wherein, selecting a preferable execution plan from the execution plans according to a judgment criterion comprises:
optimizing the execution plans, and selecting the preferable execution plan from the optimized execution plans.

6. The method according to claim 3, after selecting a preferable execution plan from the execution plans according to a judgment criterion, further comprising:
optimizing the preferable execution plan;
wherein scheduling the operations in the preferable execution plan and executing the operations on physical storage data comprises:
scheduling the operations in the optimized preferable execution plan and executing the operations on physical storage data.

7. The method according to claim 4, after selecting a preferable execution plan from the optimized execution plans according to a judgment criterion, further comprising:
optimizing the preferable execution plan:
wherein scheduling the operations in the preferable execution plan and executing the operations in the preferable execution plan on physical storage data in one of the formats comprises:
scheduling the operations in the optimized preferable execution plan and executing the operations on physical storage data.

8. The method according to claim 3, wherein optimizing the execution plans comprises:
searching the space of the execution plans and obtaining the optimized execution plans according to the judgment criterion.

9. The method according to claim 6, wherein the optimizing is based on any one or any combination of a genetic algorithm, evolutionary algorithm, simulated annealing algorithm, branch and bound algorithm, hill climbing algorithm, heuristic algorithm, artificial neural network algorithm or dynamic programming algorithm.

10. The method according to claim 7, wherein the optimizing is based on any one or any combination of a genetic algorithm, evolutionary algorithm, simulated annealing algorithm, branch and bound algorithm, hill climbing algorithm, heuristic algorithm, artificial neural network algorithm or dynamic programming algorithm.

11. The method according to claim 3, wherein the judgment criterion comprises experience rules, or time cost or space cost of the execution plan, or the combination of the time cost and space cost of the execution plan.

12. The method according to claim 11, wherein when the judgment criterion comprises the experience rules, selecting a preferable execution plan from the execution plans according to a judgment criterion comprises:
selecting a preferable execution plan from the execution plans according to an algorithm based on priorities of the experience rules, or algorithm based on weights of experience rules.

13. The method according to claim 11, when the judgment criterion comprises the time cost, further comprising:
dividing an execution plan into basic operations,
multiplying the time cost of each of the basic operations by the executing times of each of the basic operations;
summing the multiplying results of the basic operations to obtain the total time of the execution plan.

14. The method according to claim 1, wherein the invocation from the application is in XML or in a customized format which is in compliance with LALR grammar.

15. The method according to claim 1, wherein the intermediate form comprises a syntax tree or a document object model tree.

16. A machine readable medium, wherein visual appearance of a document is described by an abstract universal document model, the machine readable medium having instructions stored thereon that when executed cause a machine to:
parse an invocation from an application, the invocation indicating operations on the universal document model,
generate an execution plan which comprises operations on physical storage data; and
schedule the operations in the execution plan and executing the operations in the execution plan on physical storage data.

17. The machine readable medium according to claim. 16, having instructions stored thereon that when executed cause the machine to:
parse an invocation from an application to build an intermediate form which comprises objects and/or operations of the abstract universal document model; and
convert the intermediate form into an execution plan which comprises operations on physical storage data.

18. The machine readable medium according to claim 17 having instructions stored thereon that when executed cause the machine to:
convert the intermediate form which comprises objects and/or operations of the abstract universal document model into execution plans;
select a preferable execution plan from the execution plans according to a judgment criterion; and
schedule the operations in the preferable execution plan and execute the operations in the preferable execution plan on physical storage data.

19. A computer program product for implementing a docbase management system, wherein visual appearance of a document is described by an abstract universal document model, the computer program product while run on a machine causes the machine to:
parse an invocation from an application, the invocation indicating operations on the universal document model,
generate an execution plan which comprises operations on physical storage data; and
schedule the operations in the execution plan and executing the operations in the execution plan on physical storage data.

20. The computer program product according to claim 19, while run on the machine causes the machine to:
parse an invocation from an application to build an intermediate form which comprises objects and/or operations of the abstract universal document model; and
convert the intermediate form into an execution plan which comprises operations on physical storage data.
